(19) United States
(12) Patent Application Publication
(10) Pub. No.: US 2024/0343344 A1
(43) Pub. Date: Oct. 17, 2024

(54) Actuating Arrangement for a Transmission and Vehicle

(71) Applicant: ZF Friedrichshafen AG, Friedrichshafen (DE)

(72) Inventors: Hagen Doepfert, Lindau (DE); Thomas Riedisser, Sigmarszell (DE); Peter Ziemer, Bad Woerishofen (DE); Michel Wiemer, Weingarten (DE); Kevin Kruse, Tübingen (DE)

(21) Appl. No.: 18/634,331

(22) Filed: Apr. 12, 2024

(30) Foreign Application Priority Data
Apr. 13, 2023 (DE) DE102023203343.7

(51) Int. Cl. B62M 25/00; F16H 63/30

(52) U.S. Cl. CPC B62M 25/00; F16H 63/30; F16H 2063/3089; F16H 2063/3093

(57) ABSTRACT

An actuating arrangement for a transmission includes a pivotable pawl (14) and a rotatable shift drum (10). By rotating in a first rotational direction from a first into a second angular position, the shift drum (10) is configured to push the pawl (14) with the actuating surface (20) out of an engaged position into a released position and by rotating in the second rotational direction from the second into the first angular position to enable the pawl (14) to drop out of the released position into the engaged position. The actuating arrangement includes an actuating device (30) configured to adjust the pawl (14) out of the released position into the engaged position. The pawl (14) is adjusted by the actuating device (30) out of the released position into the engaged position only in a third angular position of the shift drum (10) between the first and the second angular position.

### CROSS-REFERENCE TO RELATED APPLICATION

The present application is related and has right of priority to German Patent Application No. DE102023203343.7 filed on Apr. 13, 2023, which is incorporated by reference in its entirety for all purposes.

### TECHNICAL FIELD

The present invention relates generally to an actuating arrangement for a transmission. The invention further relates generally to a vehicle.

### BACKGROUND

Many transmissions are shifted by shift drums. By rotating the shift drum, various shifting elements can be centrally shifted in order to provide a desired gear. For example, various rotational elements of planetary gear sets of the transmission are connected fixedly in terms of rotation to one another depending on the rotational position of the shift drum. An engagement of a pawl with a shift element part can be released or produced by the rotational movement. For example, it is possible to shift up or shift down depending on the rotational direction.

The pawl is brought into engagement with the shift element part, for example, in order to fix this shift element part or to connect the shift element part fixedly in terms of rotation to a different part. In an engaged position, an end region of the pawl then engages with an outer toothing of the shift element part, for example. However, the shift element part can still rotate before and during an adjustment of the pawl into engagement with the shift element part. Depending on the rotational speed, the adjustment speed of the pawl and also the position of the toothing relative to the pawl during the attempted engagement, however, the pawl can be undesirably repelled. For example, a pawl which is engaged slowly with a rapidly rotating shift element part can invariably strike a tooth tip of the outer toothing and thus rebound off the shift element part. The pawl can then start to rattle. The rattling can lead to increased wear on the pawl and the shift element part. The pawl then comes into engagement with the outer toothing only after some time, by accident or even not at all, is held there by a frictional connection and thus terminates the relative rotation of the shift element part. Depending on the travel status, a shifting process can last a very long time or not be possible at all. In this regard, there is a need for a more reliable actuating arrangement for a transmission.

### BRIEF SUMMARY

Example aspects of the invention provide an improved actuating arrangement for a transmission.

A first example aspect of the invention relates to an actuating arrangement for a transmission. A transmission can be a device which transmits a drive torque from a drive to an output. The transmission can transmit the drive torque from a motor to a tire of a vehicle, for example. The transmission can also transmit muscular force from a pedal crankshaft to a wheel, for example. The transmission can be configured to provide different gears which can be switched for a torque transmission. To this end, for example, the transmission can have respective spur gear stages and alternatively or additionally respective planetary gear sets. The transmission can preferably be configured as a transmission of a bicycle or alternatively as a transmission of a passenger motor vehicle. In a bicycle, for example, the transmission can be configured as a hub transmission or bottom bracket transmission. A gear can provide a fixed gear ratio between an input and an output of the transmission, for example.

The actuating arrangement has a shift drum. The shift drum can be a component which brings about a change of gear of the transmission by the actuation thereof. For example, the shift drum can be rotated in order to actuate different shift elements. By the shift drum, for example, the gears of a transmission can be selected in turn centrally by a single actuation. The shift drum can be rotated at least in a first rotational direction and a second rotational direction opposing thereto. For example, it is possible to shift up and shift down depending on the rotational direction and alternatively or additionally depending on the angular position of the shift drum. The shift drum is rotatably mounted about the longitudinal axis thereof, for example.

The shift drum has at least one actuating surface. The actuating surface can be a partial region of an outer circumferential surface of the shift drum. The actuating surface can be configured, for example, to be at least partially inclined relative to a tangent of an imaginary cylindrical shift drum. The actuating surface can form at least one part of a cam on the shift drum, for example. The shift drum can be configured as a metallic component, for example. The shift drum can have a cylindrical basic shape, wherein a lateral surface can have a shape with cams deviating from the cylindrical shape.

The actuating arrangement has a pivotably mounted pawl. The pawl can be pivotably mounted, for example, on a housing of the transmission, for example by a bolt. The actuating arrangement can also have a plurality of pawls which can be mounted together on the bolt or even separately. The following explanations apply equally to an actuating arrangement with a plurality of pawls, if applicable.

The pawl can be adjusted by pivoting between an engaged position in which the pawl is in engagement with an assigned shift element part and a released position in which the pawl releases the assigned shift element part. In the engaged position, for example, an end region of the pawl facing away from the shift drum can engage with an outer toothing of the shift element part. Thus, the shift element part can no longer rotate about the axis of rotation, for example. In the released position, the shift element part cannot be in engagement with the outer toothing of the shift element part, for example. The shift element part can thus rotate freely about the axis of rotation, for example. The pawl can be configured as a metallic component, for example.

The shift drum can be configured, for example, to push the pawl by rotation out of engagement with a shift element part in order to actuate a shift element of the transmission. As a result, a gear change can take place. In specific positions of the shift drum, the pawl can come into engagement with the shift element part. To this end, the pawl can be pretensioned in the direction of the shift element part by a spring, for example. Depending on the gear, the shift drum can be configured to push a pawl by rotation out of engagement with a shift element part in order to actuate the shift element of the transmission. “Depending on the gear” can also refer to a current gear, a gear change or even a gear which is engaged. The pawl can be configured as a movable metallic part which is pivoted by the action of the shift drum. To this end, an end of the pawl can be brought into contact with the shift drum in at least specific shift states. A different end of the pawl can be configured to engage with the shift element part. An actuating region can protrude from a region of the drum body which is adjacent in the circumferential direction, for example. An actuating region can be formed by one side of a cam of the drum body, for example.

A shift element of the transmission can connect together fixedly in terms of rotation two elements of the transmission, for example, such as rotational elements of a planetary gear set or shafts of a spur gear stage. For example, the shift element can be adjusted between an open and a closed state by an actuation of a shift element. In the open state, the shift element cannot transmit any torque, for example. In the closed state, the shift element can transmit a torque, for example. A shift element can be configured as a positive coupling, for example. A shift element can function as a brake, a movable part of the transmission being able to be fixed thereby. A shaft can be permanently connected fixedly in rotation to the shift element part.

The shift element part can be configured as half of a coupling of the shift element, for example. The shift element part can rotate at least in specific gears of the transmission when applying a drive torque, for example. At least in specific gears, the shift element part can be supported on the pawl and thus prevented from rotation, for example. For example, in one gear the pawl can be in engagement with an outer toothing of the shift element part, the pawl being able to be pushed out of engagement therewith by the shift drum for changing into a different gear. The shift element part has on the outer circumference a toothing for the engagement with the pawl, for example. The shift element part can be configured as a brake ring, for example.

By rotating the shift drum, for example, an actuating region can push against the pawl and thus release the pawl from engagement with the shift element part. Depending on the angular position of the shift drum, the pawl can then be pushed out of engagement with the shift element part. Specific rotational angular positions of the shift drum can correspond in each case to a gear of the transmission. For example, the engagement of the pawl with the shift element part can be released both in a first and in a second gear. However, in further gears, for example a third gear, the pawl can be in engagement with the shift element part.

By rotating in the first rotational direction from a first angular position into a second angular position, the shift drum is configured to push the pawl with the actuating surface out of the engaged position into the released position. To this end, the actuating surface can bear against the pawl and, for example, pivot the pawl out of engagement. An end of the pawl facing away from the shift drum is thus lifted off the shift element part, for example. The shift drum can thus directly bring about the adjustment of the pawl out of the engaged position into the released position, for example.

By rotating in the second rotational direction from the second angular position into the first angular position, the shift drum is configured to enable the pawl to drop out of the released position into the engaged position, for example due to the actuating surface. For example, the actuating surface is rotated back again so that the pawl can be pivoted back into the engaged position thereof. The adjusting movement of the pawl back into the engaged position is thus no longer blocked by the shift drum. In the second angular position, however, the actuating surface can bear against the pawl and hold the pawl in the released position. The actual adjusting movement of the pawl out of the released position, however, can be brought about by a different component, such as a spring element.

The actuating arrangement has an actuating device which is configured to adjust the pawl out of the released position into the engaged position. As a result, the adjustment movement into the engaged position can take place with significant force and alternatively or additionally at high speed. Additionally the adjusting movement into the engaged position can be decoupled from a movement of the shift drum. The shift drum only has to enable this adjusting movement, for example. As a result, the pawl can be brought into engagement with the shift element part in a particularly reliable manner.

The pawl is adjusted by the actuating device out of the released position into the engaged position only in a third angular position of the shift drum, when the shift drum is rotated in the second rotational direction. The third angular position is between the first angular position and the second angular position. Starting from the first angular position when rotating in the first rotational direction, the shift drum initially passes the third angular position before the second angular position is reached, for example. Starting from the second angular position when rotating in the second rotational direction, the shift drum initially passes the third angular position before the first angular position is reached, for example.

The movement of the pawl in the direction of the engaged position thus starts only when the shift drum has reached the third angular position when rotated in the second rotational direction, for example. Thus, in this manner a type of adjustment hysteresis can be implemented. Thus, with the rotation of the shift drum out of the second angular position in the second rotational direction, the pawl does not follow a contour of the actuating region of the shift drum, for example. Rather, the end of the pawl facing the shift drum is lifted away from the actuating region of the shift drum, for example. Thus when the shift drum is rotated in the second rotational direction starting from the second angular position, the pawl remains in the released position thereof until the third angular position is reached by the shift drum, for example. The pawl does not move, for example. However, after the third angular position has been reached, the pawl starts to follow in the direction of the engaged position. This adjusting movement can then be at a higher speed than might otherwise be possible when applying the pawl against the actuating region, due to an inclination of the actuating region, a shape of the actuating region and a rotational speed of the shift drum. As a result, the pawl can be brought into engagement with the shift element part in a particularly reliable manner. The actuating arrangement can delay a start of the dropping of the pawl, for example, for adjusting out of the released position into the engaged position, when rotating the shift drum in the second rotational direction from the second angular position into the third angular position.

The actuating device can be configured to apply an adjusting force onto the pawl only when the third angular position is reached by the shift drum rotating from the second angular position in the second rotational direction. A corresponding force application element, such as a spring, can be previously decoupled from the pawl or fixed, for example. However, the adjusting force can also act permanently on the pawl, for example by the pawl being pretensioned by a spring element into the engaged position. The actuating arrangement can be configured, for example, to block an adjusting movement of the pawl out of the released position into the engaged position or an application of force on the pawl for the adjustment thereof into the engaged position, as long as the shift drum has not yet reached the third angular position when rotated from the second angular position in the second rotational direction. The actuating arrangement can be configured, for example, to enable an adjusting movement of the pawl out of the released position into the engaged position as soon as the shift drum has reached the third angular position when rotated from the second angular position in the second rotational direction.

In one example embodiment of the actuating arrangement, it is provided that the actuating arrangement is configured to pivot the pawl at a greater speed when adjusted out of the released position into the engaged position than when adjusted out of the engaged position into the released position. The pawl can thus be brought into engagement with the shift element part in a particularly reliable manner, and yet a low speed can be selected for the rotation of the shift drum. For example, the shift drum can be rotated manually by a rider of a bicycle via a cable pull, without an increased risk of engaging the wrong gear with a slow actuation. When adjusting out of the engaged position into the released position the speed can be defined, for example, by the shape of the actuating surface and a rotational speed of the shift drum. When adjusting out of the engaged position, the speed can be independent of a rotational speed of the shift drum, for example. When adjusting out of the engaged position, the speed can result, for example, from a shape of a holding element on which the pawl slides when adjusted out of the released position into the engaged position. For example, when adjusted out of the engaged position into the released position the pawl can slide on the actuating surface of the shift drum, and when adjusted out of the released position into the engaged position the pawl can slide on a component of the actuating device.

In one example embodiment of the actuating arrangement, it is provided that the actuating device has an actuating element which is configured to push the pawl into the engaged position only after passing the third angular position, when the shift drum is rotated in the second rotational direction. The actuating element can be, for example, a spring element which is pretensioned by the rotation of the shift drum in the first rotational direction and into the second angular position, and alternatively or additionally by adjusting the pawl out of the engaged position into the released position. As a result, the actuating arrangement can operate passively, for example. The kinetic energy thus stored in the spring element can be used for pushing the pawl into the engaged position. However, the actuating element can also be configured, for example, as an active element, for example as a servo device.

In one example embodiment of the actuating arrangement, it is provided that the actuating element is configured as a spring element. For example, the spring element can be configured as a leaf spring or helical spring. The spring element can be configured as a metallic component, for example. A spring element can be a component which can store kinetic energy by an elastic deformation.

In one example embodiment of the actuating arrangement, it is provided that the actuating arrangement has a fastening element on which the spring element is mounted so as to be clamped by a spring action by a frictional connection. The fastening element can have a receiving opening in which the spring element is received with an end region, for example. This end region can be elastically deformed for insertion into the receiving opening. The spring element thus can be held and mounted in a simple manner. For example, the spring element can be inserted from the side into the receiving opening, while the technician compresses the end region to be inserted. The spring action can be generated, for example, by the spring element and can correspond to a spring force by which the spring element is held on the fastening element by a frictional connection.

If a plurality of pawls are provided, a corresponding spring element can be provided for each pawl as a corresponding actuating element of the actuating device. This plurality of spring elements can be configured jointly as a one-piece component. This one-piece component can be mounted so as to be clamped by the spring action on the fastening element by a frictional connection. Alternatively or additionally, the spring element can also be positively held on the fastening element. The spring element can be secured to the fastening element, for example, by a securing pin or a bolt. The fastening element can be configured, for example, as a component fastened to a transmission housing or as an integral part of the transmission housing.

In one example embodiment of the actuating arrangement, it is provided that the actuating arrangement has a holding spring which holds the pawl in the released position. As a result, a movement of the pawl can be prevented when the shift drum is rotated out of the second angular position in the second rotational direction and the actuating surface no longer supports the pawl in the released position. For example, when rotating the shift drum from the second angular position in the second rotational direction until the third angular position is reached, the holding spring can no longer be supported by the shift drum but a movement of the pawl in the direction of the engaged position can be undesired. For example, the pawl can in any case already be in contact with the outer toothing of the shift element part but not have been moved rapidly enough in order actually to come into engagement. Such a movement could be caused, for example, by vehicle vibrations, so that the pawl then starts to rattle. The holding spring can reliably prevent this.

The holding spring can be configured to push the pawl into the released position. The holding spring can be configured, for example, as a leaf spring. As a result, with an undesired deflection, for example due to a very significant vibration which overcomes the holding force of the holding spring, the pawl is also pushed back into the released position. A spring force of the actuating element which is configured as a spring element, by which the pawl is pushed from the third angular position into the engaged position, in this design can be greater than a spring force of the holding spring with which the holding spring pushes the pawl into the released position, for example. As a result, the actuating device then can reliably overcome a holding force generated by the holding spring.

The holding spring, however, can also be configured to increase a friction of the pawl in order to hold the pawl in the released position, for example relative to a design without such a holding spring. For example, in this design the holding spring pushes the pawl axially against a bearing surface on which the pawl is pivotably mounted. As a result, an adjusting force is greater in comparison with an actuating arrangement without such a holding spring. This increase in friction can reduce the risk of prematurely leaving the released position, for example due to vibrations, which is undesired. An adjusting force for pivoting the pawl is also independent of a pivoting position of the pawl. The holding spring can be configured, for example, as a corrugated spring which is arranged, for example, on a bearing bolt for the pawl and pushes axially against the pawl.

The holding spring and the actuating element which is configured as a spring element can be configured, for example, in one piece. Thus, an end region of this component forms the holding spring and an opposing end region forms the actuating element, for example. A variable spring force can be predetermined by a geometry, for example. The end region of this component forming the holding spring can be less wide, and alternatively or additionally thinner, than the end region forming the actuating element, for example. The actuating arrangement can thus have few parts. Moreover, in this manner a mounting can be particularly simple.

In one example embodiment of the actuating arrangement, it is provided that the shift drum is configured to enable the adjustment of the pawl out of the released position into the engaged position by the actuating device. For example, with the rotation from the second angular position in the second rotational direction, the shift drum can remove a blocking of the actuating element when the third angular position is reached. For example, the actuating element, which is configured as the spring element, was previously held by the shift drum or otherwise blocked, so that the spring element cannot push the pawl into the engaged position. To this end, for example, the shift drum can have a further actuating surface which is arranged, for example, axially parallel to the actuating surface which pushes the pawl out of the engaged position into the released position. This further actuating surface can push the actuating element, which is configured as a spring element, out of engagement with the pawl, for example, when the shift drum is in a position between the second angular position and the third angular position. At least when the shift drum is rotated from the second angular position in the second rotational direction, a contact of this further actuating surface with the actuating element, which is configured as a spring element, can be removed so that the actuating element, which is configured as a spring element, can push against the pawl in order to move the pawl into the engaged position. The shift drum can thus also predetermine an adjustment timing for the actuating device. The shift drum can thus form a part of the actuating device, for example. Thus, it is possible that particularly few parts are necessary.

In one example embodiment of the actuating arrangement, it is provided that the shift drum has a further actuating surface, thereby enabling the adjustment of the pawl out of the released position into the engaged position by the actuating device. This further actuating surface can be part of a further cam track which is also assigned to the pawl, for example. The shift drum can thus have two cam tracks for each pawl, for example.

In one example embodiment of the actuating arrangement, it is provided that the further actuating surface is configured on a circumferential surface of the shift drum.

The further actuating surface can be arranged, for example, as the actuating surface for pushing the pawl out of the engaged position in the circumferential surface of the shift drum. The further actuating surface can thus be simple and cost-effective to produce.

In one example embodiment of the actuating arrangement, it is provided that the further actuating surface is configured on a front surface of the shift drum. As a result, the shift drum can be of particularly short construction in the axial direction. The front surface can extend at right-angles to the axis of rotation of the shift drum, for example.

If a plurality of pawls are provided, for example, a further actuating surface which is assigned to a first pawl can also be configured in the circumferential surface and a further actuating surface which is assigned to a second pawl can be configured in the front surface.

In one example embodiment of the actuating arrangement, it is provided that the actuating device has a holding element. The holding element can be held on the shift drum. For example, the holding element can be fastened axially to the shift drum. The holding element can be rotatable around a predetermined rotation range relative to the shift drum between a first relative position and a second relative position. For example, the holding element can be configured as a ring which is slipped over the shift drum. This ring can have at least one projection which protrudes radially inwardly and which is received in a receiving region of the shift drum. The ring can, however, also have the receiving region and the shift drum can have at least one radially outwardly protruding projection. This receiving region can be groove-shaped, for example. When reaching the first relative position or the second relative position, depending on the rotational direction of the shift drum, the holding element is then entrained again by the shift drum, for example. This entrainment takes place by the projection striking against a side wall of the receiving region, for example. The axis of rotation of the holding element relative to the shift drum is coaxial with an axis of rotation of the shift drum, for example.

When rotating the shift drum in the first rotational direction, the holding element can be configured to be in its first relative position so that the pawl is pushed by the actuating surface of the shift drum out of the engaged position into the released position. The pawl is then located on the actuating surface of the shift drum, for example. When rotating the shift drum in the second rotational direction, the holding element can be configured to be in its second relative position in order to hold the pawl in the released position as far as the third angular position of the shift drum. For example, when rotating the shift drum from the second angular position in the second rotational direction, the pawl is located on the holding element and thus held in the released position at least until reaching the third angular position of the shift drum. To this end, the holding element can have a holding surface which protrudes in a cam-like manner, for example. This holding surface is shaped, for example, differently from the actuating surface of the shift drum. It is also possible to provide a spring which pretensions the pawl into the engaged position thereof, for example permanently.

In one example embodiment of the actuating arrangement, it is provided that the actuating arrangement has a housing of the transmission. The housing can be a cast component or steel component, for example. The pawl, the shift drum and the shift element part can be rotatably mounted on the housing, for example.

In one example embodiment of the actuating arrangement, it is provided that the actuating arrangement has the shift element part. The actuating arrangement can also have the entire shift element. The actuating arrangement can also have the transmission. The transmission and the shift element can also be different components from the actuating arrangement. The shift element can be part of the transmission.

A second example aspect relates to a vehicle, in particular a bicycle, with a transmission which has the actuating arrangement according to the first example aspect. Further features, embodiments and advantages can be found in each case in the descriptions of the first example aspect. Conversely, features, embodiments and advantages of the second example aspect also represent features, embodiments and advantages of the first example aspect.

A shift element of the transmission can be actuated by the actuating arrangement. The vehicle is preferably configured as a bicycle, for example as an E-bike, pedelec, cargo bike or the like. The transmission can be configured as a bicycle transmission. For example, the transmission can be configured as a hub transmission or bottom bracket transmission. The shift element can be manually actuatable, for example by rotating the shift drum by a shift lever via a shift cable.

### BRIEF DESCRIPTION OF THE DRAWINGS

Exemplary embodiments of the invention are illustrated in the following figures, in which:

FIG. 1 shows a schematic side view of a first example embodiment of an actuating arrangement for a transmission in a first state;

FIG. 2 shows a schematic side view of the actuating arrangement according to FIG. 1 in a second state;

FIG. 3 shows a schematic side view of the actuating arrangement according to FIG. 1 in a third state;

FIG. 4 shows a schematic perspective view of the actuating arrangement according to FIG. 1;

FIG. 5 shows a schematic perspective view of a second example embodiment of the actuating arrangement for a transmission;

FIG. 6 shows a schematic perspective view of a third example embodiment of the actuating arrangement for a transmission;

FIG. 7 shows a schematic side view of the actuating arrangement according to FIG. 6;

FIG. 8 shows a schematic perspective view of a fourth example embodiment of the actuating arrangement for a transmission;

FIG. 9 shows a schematic perspective view of a fifth example embodiment of the actuating arrangement for a transmission;

FIG. 10 shows a schematic side view of the actuating arrangement according to FIG. 9,

FIG. 11 shows a schematic view of the actuating arrangement according to FIG. 9 in a first state;

FIG. 12 shows a schematic side view of the actuating arrangement according to FIG. 9 in a second state;

FIG. 13 shows a schematic side view of the actuating arrangement according to FIG. 9 in a third state;

FIG. 14 shows a schematic side view of the actuating arrangement according to FIG. 9 in a fourth state;

FIG. 15 shows a schematic side view of the actuating arrangement according to FIG. 9 in a fifth state;

FIG. 16 shows a schematic side view of a fastening of an actuating element by way of example using the actuating arrangement according to FIG. 5; and

FIG. 17 shows a schematic perspective view of a fastening element for a plurality of actuating elements.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

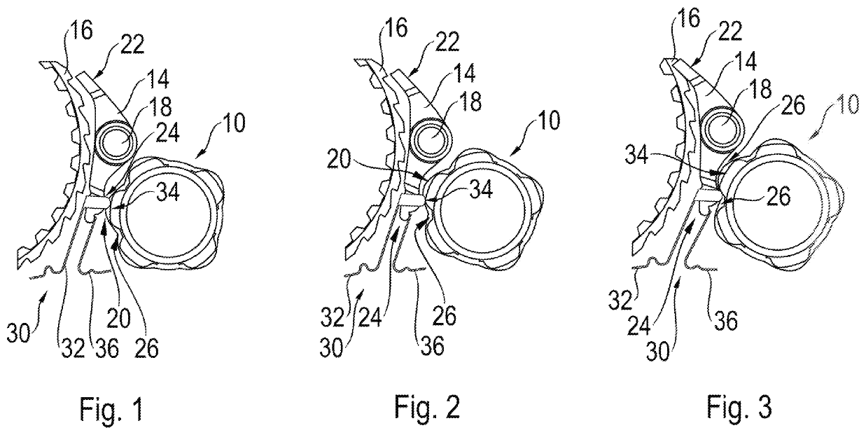

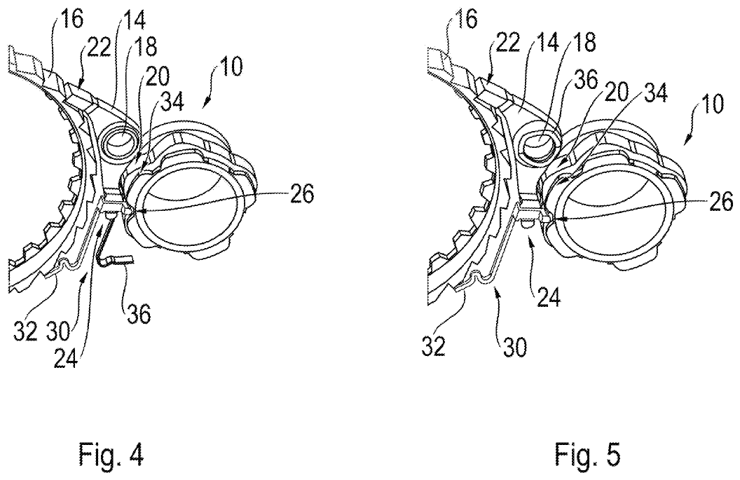

FIGS. 1 to 4 illustrate a first example embodiment of an actuating arrangement for a bicycle transmission. The actuating arrangement has a shift drum 10 with a drum body, a pawl 14 and a shift element part 16 which is configured as a brake ring. The pawl 14 is pivotably mounted on a bolt 18. The pawl 14 is adjustable between an engaged position in which the pawl 14 is in engagement with the assigned shift element part 16 and a released position in which the pawl 14 releases the assigned shift element part 16 by pivoting about the bolt 18. FIG. 1 shows the released position of the pawl 14 in which an end region 22 of the pawl 14 is spaced apart from an outer toothing of the shift element part 16. FIG. 3 shows the engaged position of the pawl 14 in which the end region 22 of the pawl 14 engages with the outer toothing of the shift element part 16 and thus blocks a rotation of the shift element part 16. The shift drum 10 is rotatably mounted in a first rotational direction and a second rotational direction opposing thereto about the longitudinal axis thereof. The shift drum 10 has a plurality of actuating surfaces 20 which are configured in the same shape and arranged over the outer circumference of the shift drum 10 as a cam track. This can be identified particularly clearly in FIG. 4. Different gears can be engaged in the bicycle transmission depending on whether a rotation of the shift element part 16 is released or blocked.

In FIG. 1, it can be identified that one of the actuating regions 20 of the shift drum 10 pushes against an end region 24 of the pawl 14 opposing the end region 22. In this position, the shift drum 10 has been moved to the left by a rotation in the image plane which is denoted as the first rotational direction. However, the shift drum 10 can also have been be moved into this position by an opposing rotation. A starting point which corresponds to a contact of the end region 22 with a base 26 of the actuating region 20 or the cam track is denoted as the first angular position. In this first angular position, which is also shown in FIG. 3, the pawl 14 is in the engaged position thereof. The shift drum 10 has reached the second angular position shown in FIG. 1 by the rotation in the first rotational direction.

Starting from the second angular position of the shift drum 10, in order to adjust the pawl 14 into the engaged position, the shift drum 10 is now rotated in the image plane to the right, i.e. in a second rotational direction opposing the first rotational direction. This rotation corresponds to the image sequence of FIG. 1 to FIG. 3. As can be already identified in FIG. 2, the actuating surface 20 enables the pawl 14 to drop out of the released position into the engaged position since the actuating surface 20 is now lifted away from the end region 24.

However, in the angular region of the shift drum 10 which is between the two positions shown in FIG. 1 and FIG. 2, the pawl 14 does not yet start to pivot in the direction of the shift element part 16 with the end region 22, in order to drop therein. The actuating arrangement has an actuating device 30 which is configured to adjust the pawl 14 out of the released position into the engaged position only when the shift drum 10 has been adjusted from the second angular position into a third annular position by the rotation thereof in the second rotational direction. Starting from the second angular position, the third angular position is located between the second angular position and the first angular position in the direction of the second rotational direction, and corresponds substantially to the state shown in FIG. 2. The actuating device 30 is configured to push the pawl 14 into the engaged position only after passing the third angular position, when the shift drum 10 is rotated in the second rotational direction from the second angular position. When adjusted out of the released position into the engaged position by the actuating device 30, the pawl 14 is pivoted at a greater speed than when the pawl 14 is adjusted out of the engaged position into the released position by the shift drum 10.

The actuating device 30 also has an actuating element 32 which is configured as a spring element. The actuating element 32 is configured to push the pawl 14 into the engaged position only after passing the third angular position, when the shift drum 10 is rotated in the second rotational direction. The shift drum 10 has a further actuating surface 34 which is configured as a cam track which is parallel to the cam track having the actuating surface 20. This can be identified particularly clearly in FIG. 4. In the first example embodiment, the further actuating surface 34 is thus also configured on a circumferential surface of the shift drum 10. The further actuating surface 34 is configured to hold the actuating element 32 in a pretensioned state in the region from the second angular position to the third angular position and to prevent the actuating element 32 from being pushed onto the end region 24 of the pawl 14. After passing the third angular position, the actuating element 32 slides on a flank of the further actuating surface 34 and can be deformed thereby away from the shift element part 16 toward the base 26 or the shift drum 10. This deformation can also be identified by comparing FIG. 2 with FIG. 3. As a result, the further actuating surface 34 enables the adjustment of the pawl 14 out of the released position into the engaged position by the actuating device 30. The flank of the further actuating surface 34 is steeper than a flank of the actuating surface 20, resulting in a higher adjusting speed in the direction of the engaged position in comparison with an adjusting speed in the direction of the released position.

In the first example embodiment, the actuating device 30 has a holding spring 36 which holds the pawl 14 in the released position. In the first example embodiment, the holding spring 36 is configured as a leaf spring which pushes against the end region 24 of the pawl 14 in the direction of the shift element part 16 and thus pretensions the pawl 14 in the direction of the released position thereof. As a result, the pawl 14 is prevented from pivoting in the direction of the engaged position due to vibrations, when the actuating surface 20 of the shift drum 10, when rotated in the second rotational direction from the first angular position into the second angular position, has already lost contact with the end region 24 of the pawl 14. Moreover, with such an undesired adjustment, the holding spring 36 rotates the pawl 14 back into the released position thereof.

In each of the states shown in FIG. 1 to FIG. 3, the spring force of the actuating element 32 is greater than a spring force of the holding spring 36. Both in the maximum pretensioned state thereof when the further actuating surface 34 has pushed the actuating element 32 as shown in FIG. 1 toward the shift element part 16, and in the maximum relaxed state thereof when the actuating element 32 has been deformed toward the base 26, the spring force of the actuating element 32 is thus greater than the spring force of the holding spring 36 in order to be able to push the pawl 14 reliably into the engaged position.

In the first example embodiment, the actuating element 32 and the holding spring 36 are configured as separate components. In a further example embodiment, the actuating element 32 and the holding spring 36 are configured by a common component which forms the respective springs on the respective ends.

FIG. 5 shows a second example embodiment of the actuating arrangement. In this example embodiment, only the holding spring 36 is configured differently from that in the first example embodiment. The holding spring 36 in the second example embodiment is configured as a corrugated spring which pushes against the pawl 14 axially around the bolt 18. Thus, a frictional force which has to be overcome in order to pivot the pawl 14 is greater than in the first example embodiment. The pawl 14 is also held thereby in the released position and a risk of an undesired adjustment by external influences is reduced. In the second example embodiment, the holding spring 36 is not able to push the pawl 14 in the direction of the released position. To this end, however, an adjusting force for pivoting the pawl 14 between the released position and the engaged position thereof, apart from an engagement force acting between the shift element part 16 and the end region 22 of the pawl 14, is substantially constant over the entire pivoting range thereof.

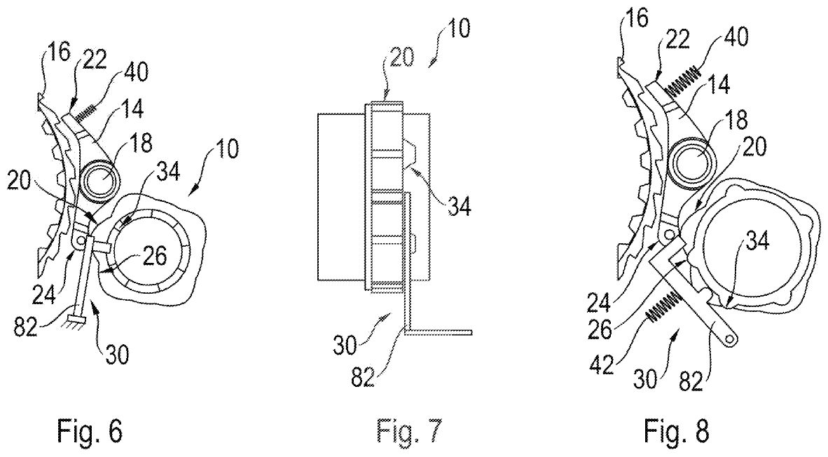

FIG. 6 and FIG. 7 show a third example embodiment of the actuating arrangement. Only the differences relative to the first example embodiment are described.

In the third example embodiment, the one locking element 82 is also configured as a spring element which enables the pivoting of the pawl 14 from the third angular position by deformation. The locking element 82, however, does not push the pawl 14 into the engaged position. Rather, the locking element 82 only blocks the pivoting of the pawl 14 with the end region 22 in the direction of the shift element part 16 by an engagement with the end region 24 of the pawl 14. The adjustment of the pawl 14 in the direction of the engaged position is brought about by an additional actuating element which is configured as a spring element 40. The additional spring element 40 is supported with one end on a housing and with an opposing end on the end region 22 of the pawl 14. The additional spring element 40 is pretensioned to this end.

Moreover, in the third example embodiment, the further actuating surface 34 is not configured as part of a cam track on the circumferential surface of the shift drum 10 but as part of a cam track of a front surface of the shift drum 10. This can be identified particularly clearly in FIG. 7. The further actuating surface 34 thus pushes the locking element 82 axially away from the end region 24 of the pawl 14 in order to release the engagement therein and to enable an abrupt adjustment of the pawl 14 into the engaged position thereof. The locking element 82 is thus axially controlled.

In the third example embodiment, the holding spring 36 is dispensed with. Rather, the locking element 82 undertakes the function thereof since the locking element 82 holds the pawl 14 in the released position until the third angular position is reached.

FIG. 8 shows a fourth example embodiment of the actuating arrangement. Only the differences relative to the third example embodiment are described.

In the fourth example embodiment, the locking element 82 is configured as a lever instead of as a spring element. This lever is pivotably mounted about a bolt with an end facing away from the pawl 14. The locking element 82 is also pretensioned by an additional spring element 42 for engagement with the pawl 14 on the end region 24 thereof. As in the third example embodiment, this engagement blocks the pivoting of the pawl 14 into the engaged position and holds the pawl 14 in the released position. The further actuating surface 34 which is now once again arranged on the circumferential surface of the shift drum 10, as in the first example embodiment, pushes the locking element 82 out of engagement with the pawl 14 when the third angular position is passed, when the shift drum 10 is rotated from the second angular position in the second rotational direction. The pawl 14 is thus released and abruptly adjusted by the spring element 40 into the engaged position. The locking element 82 is thus radially controlled. In the fourth example embodiment, the further actuating surface 34 and the actuating surface 20 are offset relative to one another in the circumferential direction.

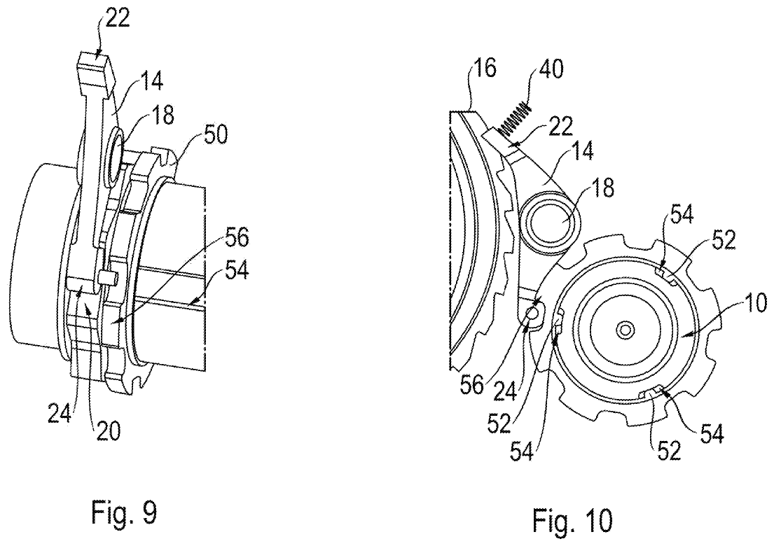

FIG. 9 to FIG. 15 illustrate a further example embodiment of the actuating arrangement in which the actuating device 30 is designed differently. The actuating device 30 has a holding element 50 which is held on the shift drum 10 and can be rotated around a predetermined rotation range relative to the shift drum 10 between a first relative position and a second relative position. The holding element 50 is configured as a ring which is slipped over the shift drum 10 and bears axially against the cam track having the actuating surface 20. Radially inwardly, the holding element 50 has three projections 52 which in each case are arranged in an assigned groove 54 of the shift drum 10. These grooves 54 permit the holding element 50 to be rotated around the predetermined rotation range relative to the shift drum 10. When reaching the end of the predetermined rotation range, the holding element 50 is then entrained with a further rotation of the shift drum 10 by the respective side wall of the grooves 54 on the projections 52.

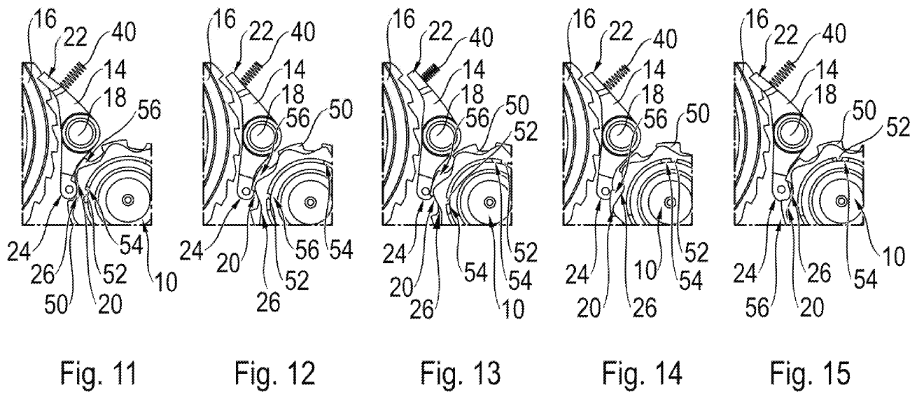

When rotating the shift drum 10 in the first rotational direction, the holding element 50 is configured to be in its first relative position so that the pawl 14 is pushed by the actuating surface 20 of the shift drum 10 out of the engaged position into the released position. Such a rotation of the shift drum 10 to the left is illustrated, for example, by the sequence of FIG. 11, FIG. 12, and FIG. 13. The projections 52 strike against a right-hand side wall of the respective groove 54 and the holding element 50 is entrained. FIG. 13 thus illustrates the shift drum 10 in the second angular position with the holding element 50 in its first relative position. FIG. 11 illustrates the shift drum 10 in the first angular position with the holding element 50 in its first relative position.

When rotating the shift drum 10 in the second rotational direction, the holding element 50 is configured to be in its second relative position in order to hold the pawl 14 in the released position as far as the third angular position of the shift drum 10. When reaching the second angular position of the shift drum 10, as shown in FIG. 13, the rotational direction of the shift drum 10 is changed and it is rotated to the right. The holding element 50 initially remains in rotational position so that relative to the shift drum 10 the holding element 50 moves to the left into a second relative position. As a result, a holding surface 56 of the holding element 50 initially remains in position despite the rotation of the shift drum 10 in the second rotational direction. The holding surface 56 is configured as part of a cam-like design of a circumferential surface of the holding element 50. As can be identified in FIG. 13 and FIG. 14, the pawl 14 is positioned with the end region 24 thereof on the holding surface 56, which to this end has a pin protruding axially in the direction of the holding element 50. As a result, a restoring of the pawl 14 into the engaged position is initially blocked. From a certain rotational position, namely a rotation of the shift drum 10 in the second rotational direction by a width of the groove 54 from the second angular position, then the holding element 50 is entrained again. As a result, the holding surface 56 is moved along the pawl 14. When the third angular position of the shift drum 10 is reached, a corner of a protruding region of the holding surface 56 is still in engagement with the end region 24 of the pawl 14. This is illustrated in FIG. 14. With a further rotation, the end region 24 passes this corner and the pawl 14 can then be pushed almost abruptly by the spring element 40 in the direction of the base 26. Thus, the pawl 14 then passes at a high adjusting speed into the engaged position until the shift drum 10 has reached the first angular position again.

With a subsequent rotation of the shift drum 10 in the first rotational direction, after sufficient rotation the holding element 50 bears again with the projections 52 against the side walls of the grooves 54 and rotates therewith, which corresponds to the first relative position. In this first relative position, the holding surface 56 is positioned relative to the actuating surface 20 of the shift drum 10 such that the end region 24 of the pawl 14 slides on the actuating surface 20 rather than on the holding surface 56. The holding surface 56 is thus rotated out of a possible contact with the end region 24 of the pawl 14. As a result, the pawl 14 can then correspondingly be pushed out of the engaged position into the released position by the actuating region 20 of the shift drum 10 with a slight expenditure of force until the second angular position is reached.

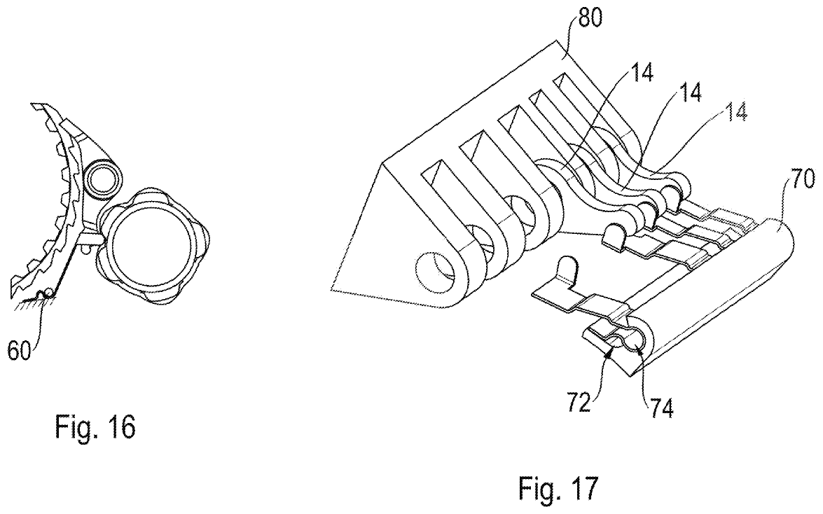

FIG. 16 illustrates a fastening of the actuating element 32, which is configured as a spring element, on the basis of the embodiment of FIG. 5. A securing pin 60, which fixes the actuating element 32 on the housing in a wave-shaped region, is provided to this end. A partial region of the actuating element 32 bears flat against the housing behind the securing pin 60 and thus forms an abutment for the spring unit. This pin can also be pushed by a plurality of actuating elements 32 which are arranged in parallel and adjacent to one another for the fixing thereof.

FIG. 17 illustrates schematically in a perspective view a fastening element 70 for a plurality of actuating elements 32. This fastening element 70 is configured as a type of sleeve which forms a receiving opening 72 for the plurality of actuating elements 32. These actuating elements can be inserted for the mounting and fastening thereof from the side into the receiving opening 72 by compressing an end region 74 of the actuating element 32 respectively to be arranged therein. In an alternative example embodiment, the fastening element 70 is received in the receiving opening 72 without pretensioning and can then be mounted without compression. The actuating elements 32, which are configured as spring elements, are thus mounted so as to be clamped by a spring action on the fastening element 70 by a frictional connection or positively, depending on whether the spring is also pretensioned or not relative to the bore in the unclamped state.

In FIG. 17 it can be identified that the actuating elements 32, which are arranged adjacent to one another, are configured in one piece as a common spring component. As a result, these actuating elements can be jointly mounted and fastened in a simple manner. Moreover, the plurality of pawls 14 which are arranged adjacent to one another are partially shown, the pawls being jointly mounted with a bearing pin, not shown, in a pivotable manner on a further fastening element 80. For each pawl 14, the shift drum 10 accordingly has corresponding cam tracks with actuating surfaces 20 and in each case further cam tracks with further actuating surfaces 34 for the release of the actuating elements 32. Each pawl 14 is assigned a shift element part 16 which is fixed by the respective pawl 14 in the engaged position on the housing. Thus, depending on the rotational position of the shift drum 10, a plurality of shift element parts 16 can be blocked or released and thereby a plurality of gears can be shifted.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

10 Shift drum
14 Pawl
16 Shift element part
18 Bolt
20 Actuating surface
22 End region
24 End region
26 Base
30 Actuating device
32 Actuating element
34 Actuating surface
36 Holding spring
40 Spring element
42 Spring element
50 Holding element
52 Projections
54 Groove
56 Holding surface
60 Securing pin
70 Fastening element
72 Receiving opening
80 Fastening element
82 Locking element

1-13. (canceled)

14. An actuating arrangement for a transmission, comprising:
a pivotably mounted pawl (14); and
a shift drum (10) with an actuating surface (20), the shift drum (10) rotatable in a first rotational direction and a second opposite rotational direction, the pawl (14) adjustable by pivoting between an engaged position and a released position, the pawl (14) engaged with an assigned shift element part (16) in the engaged position, the pawl (14) releasing the assigned shift element part (16) in the released position,
wherein, by rotating in the first rotational direction from a first angular position into a second angular position, the shift drum (10) is configured to push the pawl (14) with the actuating surface (20) out of the engaged position into the released position,
wherein, by rotating in the second rotational direction from the second angular position into the first angular position, the shift drum (10) is configured to allow the pawl (14) to drop out of the released position into the engaged position,
wherein the actuating arrangement comprises an actuating device (30) configured to adjust the pawl (14) out of the released position into the engaged position, the pawl (14) adjustable by the actuating device (30) out of the released position into the engaged position only in a third angular position of the shift drum (10) when the shift drum (10) rotates in the second rotational direction,
wherein the third angular position is between the first angular position and the second angular position.

15. The actuating arrangement of claim 14, wherein the actuating arrangement is configured to pivot the pawl (14) at a greater speed when adjusting out of the released position into the engaged position than when adjusting out of the engaged position into the released position.

16. The actuating arrangement of claim 14, wherein the actuating device (30) comprises an actuating element (32) configured to push the pawl (14) into the engaged position only after passing the third angular position when the shift drum (10) is rotated in the second rotational direction.

17. The actuating arrangement of claim 16, wherein the actuating element (32) comprises a spring.

18. The actuating arrangement of claim 17, wherein the actuating arrangement comprises a fastening element (70), on spring mounted on the fastening element (70).

19. The actuating arrangement of claim 14, wherein the actuating arrangement comprises a holding spring (36) configured to hold the pawl (14) in the released position.

20. The actuating arrangement of claim 14, wherein the shift drum (10) is configured to allow adjustment of the pawl (14) out of the released position into the engaged position by the actuating device (30).

21. The actuating arrangement of claim 20, wherein the shift drum (10) comprises a further actuating surface (34) configured to allow adjustment of the pawl (14) out of the released position into the engaged position by the actuating device (30).

22. The actuating arrangement of claim 21, wherein the further actuating surface (34) is arranged on a circumferential surface of the shift drum (10).

23. The actuating arrangement of claim 21, wherein the further actuating surface (34) is arranged on a front surface of the shift drum (10).

24. The actuating arrangement of claim 14, wherein:
the actuating device (30) comprises a holding element (50) on the shift drum (10);
the actuating device (30) is rotatable around a predetermined rotation range relative to the shift drum (10) between a first relative position and a second relative position;
when rotating the shift drum (10) in the first rotational direction, the holding element (50) is configured to be in the first relative position such that the pawl (14) is pushed by the actuating surface (20) of the shift drum (10) out of the engaged position into the released position; and
when rotating the shift drum (10) in the second rotational direction, the holding element (50) is configured to be in the second relative position in order to hold the pawl (14) in the released position as far as the third angular position of the shift drum (10).

25. The actuating arrangement of claim 14, wherein the actuating arrangement comprises the shift element part (16).

26. A vehicle, comprising a transmission with the actuating arrangement of claim 14, wherein a shift element of the transmission is actuatable by the actuating arrangement.

27. The vehicle of claim 26, wherein the vehicle is a bicycle.
